(19) United States
(12) Patent Application Publication
(10) Pub. No.: US 2012/0141637 A1
(43) Pub. Date: Jun. 7, 2012

(54) Multiple Compartment Coffee Packaging System

(76) Inventors: Kristin Ann MOONEY, New York, NY (US); Derek J. ROMEO, Ridgewood, NJ (US)

(21) Appl. No.: 12/962,145

(22) Filed: Dec. 7, 2010

(51) Int. Cl. B65D 81/00; A23F 5/00

(52) U.S. Cl. 426/108; 426/395

(57) ABSTRACT

A packaging system and method for packaging roast and ground coffee products, the packaging system comprising multiple containers that store the coffee and are packaged within a larger outer package that bundles the multiple containers together into one unit. The containers can have a vented film membrane that seals an opening in the container, the film membrane having a vent opening that allows for a release of gas build up from within the container through the vent opening. Additionally, the outer package completely surrounds the multiple packages and further contains a one-way valve that allows for release of the gases accumulated within exit through the valve while preventing gases from entering through the valve and into the package. In another aspect, the containers can have a one-way valve directly on the container body for release of gases therethrough.

### FIELD

This application generally relates to a coffee package and, in particular, to a multiple compartment coffee package.

### BACKGROUND

Roast and ground coffee is typically packaged in sealed containers that exclude oxygen to preserve freshness. Such containers often include relief valves or check valves because freshly packed roast and ground coffee typically releases carbon dioxide in sufficient quantities that distortion of the container walls would otherwise occur due to increased interior pressure. The relief valves permit egress of carbon dioxide while preventing or inhibiting ingress of air.

As discussed in copending U.S. patent application Ser. No. 12/688,032, some containers for roast and ground coffee comprise a self-supporting, or rigid, plastic body, sealed with a peelable film cover, and a snap-on, snap-off plastic overcap. When such containers are transported from packaging plants to retail stores, they are sometimes transported over mountains at high enough altitudes (e.g., altitudes around 7000 feet) that significant internal pressure drops are experienced. In some cases, a drop of about 5 psi may occur during transport while the container is at high altitude, and upon returning to a lower altitude, the internal pressure will remain at about 5 psi below the external pressure, which may be, e.g., about 5 psi below atmospheric pressure at sea level. This can result in significant stress on the container walls and seals.

The containers described in the above application are capable of withstanding these stresses, and provide an effective and commercially viable means to deliver fresh roast and ground coffee to the consumer. However, once a container has been opened, the roast and ground coffee in the container begins to lose certain aromatic components, and the passage of time after opening the container adversely affects the flavor of coffee beverages brewed from the roast and ground coffee. From the consumer's point of view, purchasing coffee in smaller quantities can provide a benefit by avoiding the likelihood that a portion of the coffee will become stale before it has all been used. However, purchasing coffee in larger quantities may be preferred for convenience, i.e., reducing the number of packages that must be purchased and opened in connection with a particular quantity, as well as for efficiency in use of packaging materials, and for economy.

One factor that increases the cost of coffee containers is the cost of relief valves. The valves themselves have a significant cost, and installation of the valves on containers complicates the process of making, filling and sealing the containers.

### SUMMARY

Roast and ground coffee may be packaged in multiple smaller containers bundled together into one larger unit, or overwrap, with each of the smaller containers being provided with a lidding seal having a relatively small vent opening therein that allows CO₂ to exit but essentially no air to enter. The vent opening may be formed simply by puncturing a portion of the container, without providing a mechanism to close the opening to inflow of air, i.e., without providing a relief valve associated with the vent opening. A vent opening could also be created by molding a gap in the finish area of the package. This gap and design of such gap, in combination with its interface with the seal and lid may also limit the amount of oxygen that passes through into the sealed container. The multiple primary containers combined into one secondary package provide the consumer shelf unit, significantly increasing the length of time that a purchase of a particular shelf unit can provide the purchaser fresh roast and ground coffee after initial opening. It also enables a single unit to provide the consumer with multiple instances of the experience of opening a sealed container and enjoying the aroma of fresh roast and ground coffee that has had little or no significant exposure to air.

Each of the primary containers can comprise a rigid base with an opening that is sealed with a flexible oxygen barrier membrane or film. A small vent opening can be provided in this film to allow carbon dioxide to pass therethrough. Although oxygen can pass into the primary containers after removal of the outer wrap, the rate of passage of oxygen into the containers after opening of the outer wrap or secondary container is limited by the size of the vent opening, and by the fact that the changes in external pressure that frequently occur during transport are generally not encountered during typical consumers' transportation of the packaged coffee after purchase and after removal of the outer wrap. Provision of only a simple vent opening, without incurring the expense associated with relief valves, can result in significant savings.

The outer package (or secondary package) may comprise a film with oxygen barrier properties or it may comprise an oxygen permeable material such as a paperboard overwrap. The outer package/overwrap can contain a one-way valve that permits venting of the gases released through the vent openings in the primary coffee containers without allowing inflow of air. Alternatively, the rigid base of the primary container may contain a one-way valve and therefore may be packaged with or without a secondary container.

The shelf unit may include a single overcap or lid that is able to be used to reclose the first primary container after initial opening thereof, then successively reused on additional primary containers, to prevent spillage and preserve freshness. Alternatively, two or more overcaps may be provided in each shelf unit, to accommodate the possibility of loss of the overcap over the course of using the entire volume of coffee.

### BRIEF DESCRIPTION OF THE DRAWINGS

FIG. 1 is a perspective view of a packaging system for coffee;

FIG. 2 is a perspective view of primary packages of the packaging system of FIG. 1;

FIG. 3 is a top perspective view of one of the primary packages of FIG. 2;

FIG. 4 is a perspective view of the package of FIG. 3 as it is being opened;

FIG. 5 is a cross-sectional view of the package system of FIG. 1, taken along line 5-5;

FIG. 6 is a bottom view of the primary package of FIG. 3; and

FIG. 7 is a perspective view of a primary package in accordance with a second embodiment.

### DETAILED DESCRIPTION

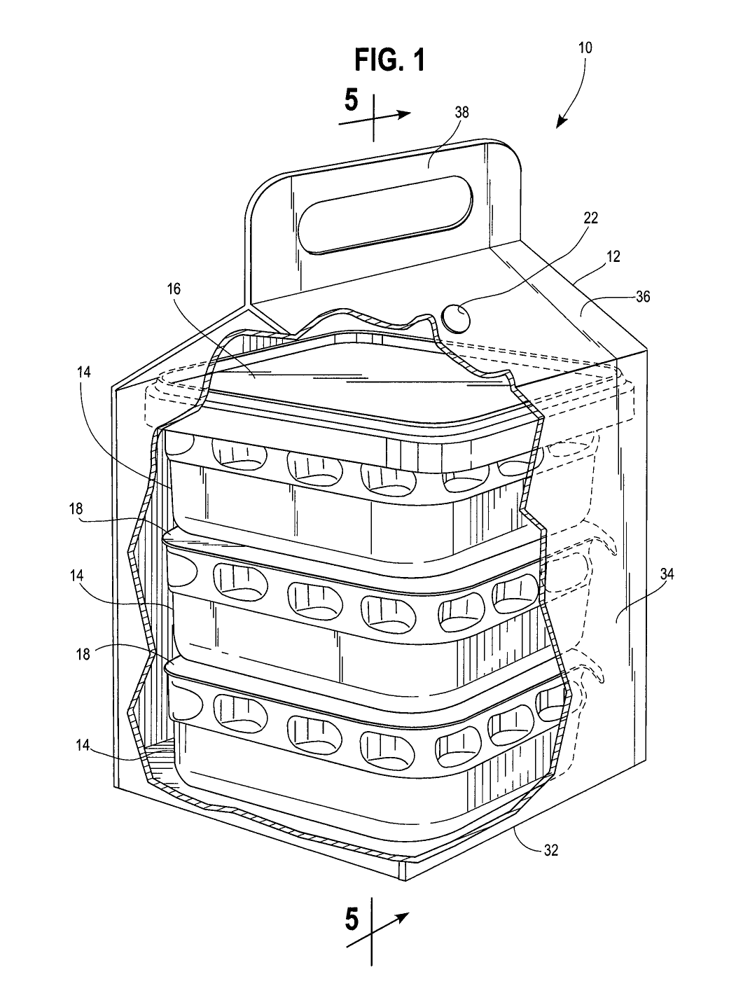

A packaging system for coffee is described herein and shown in FIGS. 1-7. One or more primary containers having a rigid base with an opening are filled with a roast and ground coffee product and the opening is sealed with a vented film membrane. The vented film membrane can comprise a film having a small vent opening therein to allow egress of carbon dioxide and other gases that may be given off by the packaged coffee. The one or more primary containers can be packaged within a secondary container that surrounds all of the one or more primary containers and provides a single package for placement on a store shelf. The secondary container can have a one-way valve that permits gases that vent through the vented film membrane of the primary containers into the interior of the secondary container to pass out of the secondary container into the atmosphere. The one-way valve in the secondary container prevents air or other gases from entering through the valve and into the interior of the secondary container, thus preserving the freshness of the packaged coffee therein. Thus, the overall packaging system is gas impervious, and after removing the secondary package, the individual primary rigid containers can preserve freshness by preventing or limiting inflow of air.

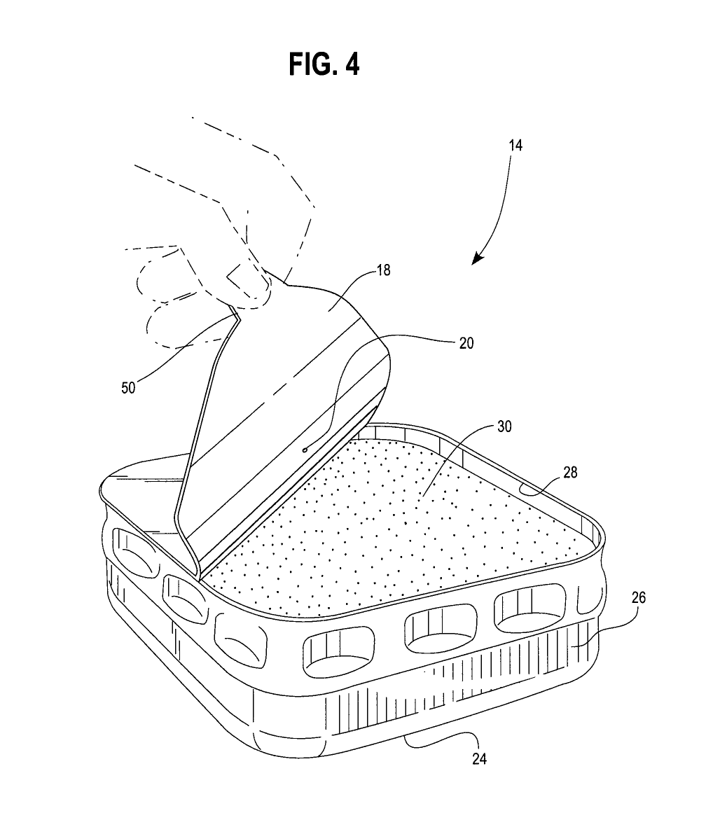

FIG. 1 shows a coffee package 10 that comprises a secondary, or outer, package 12 that surrounds multiple primary packages 14, and in the figures shown, enclosing three primary packages 14. Each of the multiple primary packages 14 can comprise a rigid or semi-rigid base that can have a bottom wall 24 with an upstanding sidewall 26. An opening 28 can be positioned at an upper edge of the sidewall 26, opposite the bottom wall 24. The inner surfaces of the bottom wall 24 and the sidewall 26 together define an interior 40 of the rigid base 14. A coffee product, such as roast and ground coffee 30, can be stored in the interior 40 of the rigid base 14, as shown in FIG. 4.

The opening 28 of the rigid base 14 can be sealed and covered by a vented film membrane 18, as shown in FIG. 3. The vented film membrane 18 can form an essentially air-tight seal over the opening 28 of the rigid base 14. However, because the freshly roast and ground coffee 30 packaged in the interior 40 of the rigid base 14 can give off gases, such as carbon dioxide, a vent 20 can be provided in the film membrane 18 to release gases through the vent 20 that may build up within the interior of the rigid base 14.

The vent 20 can allow gases to pass through the vent 20 from the interior 40 of the rigid base 14 to emit the gas from the package 14 and into the atmosphere on the other side of the film membrane 18. Where the multiple rigid bases 14 are enclosed by the secondary package 12, the released gases pass through the vent 20 and into the interior area 42 of the secondary package 12, as will be discussed in further detail below. Where the secondary package 12 has been removed upon opening the package 10, the released gases pass through the vent 20 and into the air on the other side of the film membrane 18.

Optionally, the vented film membrane 18 can contain a one-way valve, such as a small foil one-way valve placed on the vented film 18 in the location where the vent 20 would be. The foil one-way valve layer can help to prevent air from entering the base, yet can allow gases to escape through the foil valve. The foil valve layer can be adhered to the film membrane 18 by any known means, such as applying an adhesive. The foil valve layer can be any shape and in particular, can be shaped to match the shape of the film membrane 18. In one aspect, the foil can be a square. The foil valve layer can be the same material as the film membrane 18 or it can be different. The thickness of the foil valve layer is small enough such that it does not interfere with the venting of gas through the foil valve and does not provide a bulging area on the membrane 18. Other known types of one-way valves may also be used, such as a button valve or disk valve.

The secondary package 12 can comprise a bottom panel 32, an upstanding side panel 34, and a top panel 36 at an upper end of the side panel 34 and generally opposite the bottom panel 32 to form an enclosure. The inner surfaces of the bottom panel 32, the side panel 34 and the top panel 36 together form an interior area 42 of the secondary package 12 that houses the multiple rigid bases 14 stored therein. The secondary package 12 can completely enclose the multiple rigid bases 14, such that it prevents the outside air or atmosphere from contacting the outside or inside of the multiple rigid bases 14.

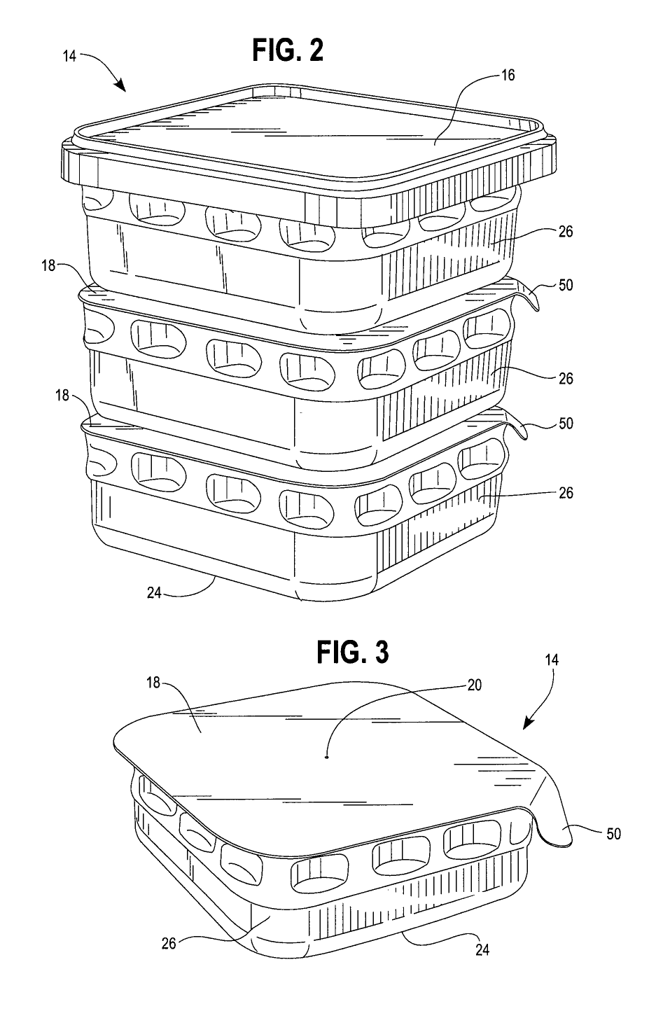

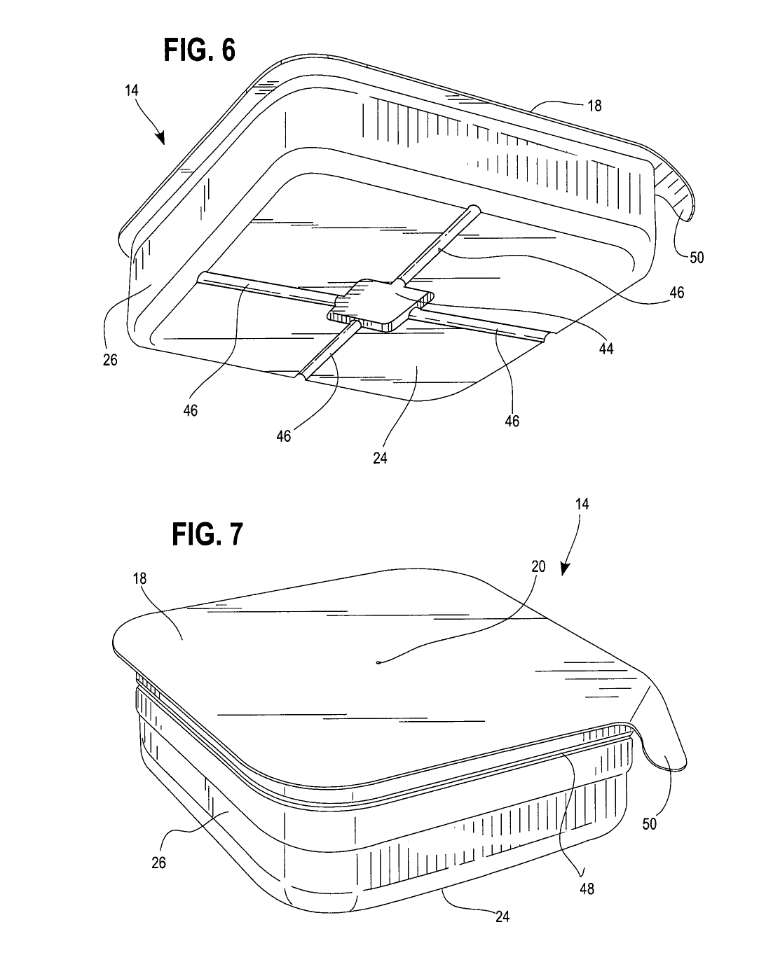

The rigid bases 14 can be stacked one on top of the other upon being packaged into the secondary package 12, as shown in FIGS. 1 and 2. The bottom wall 24 of the rigid base 14 can optionally contain channels or grooves 46 along the bottom wall 24 that emanate from an indented or recessed portion 44 also on the bottom wall 24, and in one aspect, is positioned at a midpoint location, as shown in FIG. 6. In one aspect, both the vent 20 and the indent 44 can be placed in a generally midpoint location of their respective surface, i.e., the film membrane 18 and the bottom wall 24. In another aspect, there can be at least one channel 46 that can extend from the indent 44 to an edge of the bottom wall 24. In yet another aspect, there can be at least two channels 46, and in yet another aspect, there can be more than two channels 46. The indent 44 can be positioned such that it coincides with the vent 20 of the rigid base 14 below it when in the stacked position, the indent 44 being recessed just enough from the plane of the bottom wall 24 to avoid contacting and covering the vent 20 of the adjacent sealed rigid base 14 below it. When stacked, the bottom wall 24 of an upper positioned base 14 essentially rests upon the vented film membrane 18 of a lower positioned base 14.

The placement of the indent 44 on the bottom wall 24 helps to permit gases to freely pass out of the vent 20 and along the bottom wall 24 of the above base 14. The addition of channels 46 along the bottom wall 24 that extend to the outer edge of the intersection of the bottom wall 24 and sidewall 26 can further help to guide the gases along the bottom wall 24 and to the interior area 42 of the secondary package 12 or the outer atmosphere, if the secondary package 12 is removed.

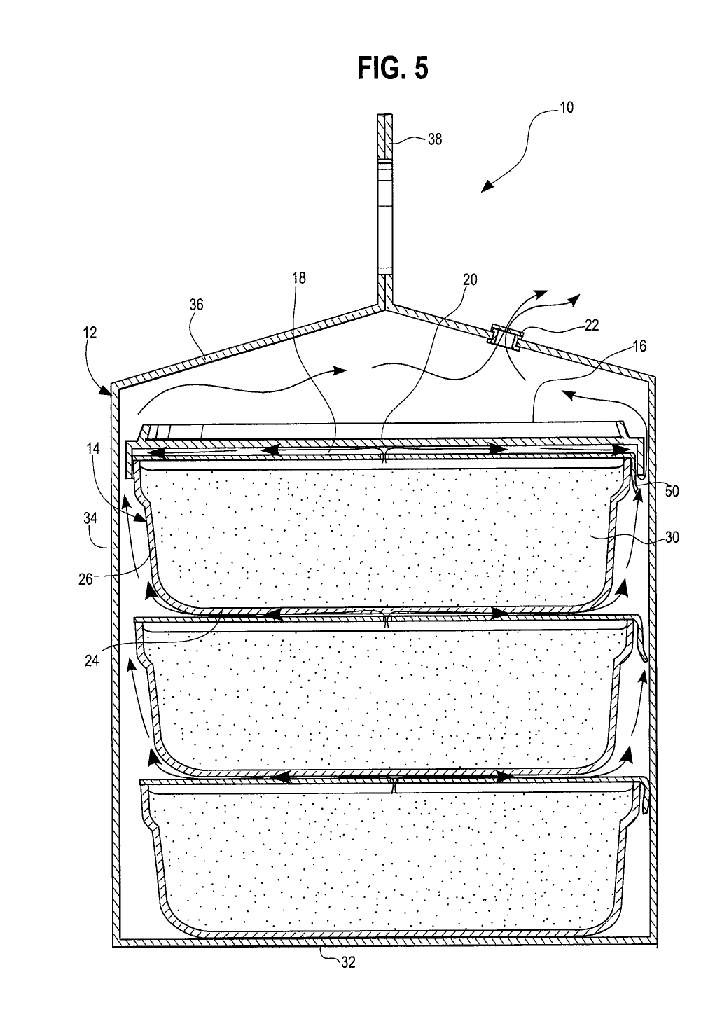

Since the packaged roast and ground coffee 30 can give off gases while in the sealed rigid base 14, these gases can pass through the vent 20 of the vented film membrane 18 and into the interior area 42 of the secondary package 12, where the path of travel of the gases are shown by arrows in FIG. 5. A one-way valve 22 can be positioned on the secondary package 12 to allow the release of the accumulated gases from the interior area 42 of the secondary package 12, through the one-way valve 22, and into the atmosphere on the outer side of the secondary package 12.

The one-way valve 22 can be positioned anywhere on the secondary package 12 and, in one aspect, can be positioned on the top panel 36. The one-way valve 22 can provide a passageway that connects an outer side of the secondary package 12 to the interior area 42 of the secondary package 12. The one-way valve 22 can be provided such that it allows the release or egress of the gases from within the interior area 42 out through the valve 22 of the secondary package 12, yet can prevent the ingress of gases from outside of the secondary package 12 into the interior area 42 of the secondary package 12. Thus, the gases that are given off from the packaged ground coffee 30 can be permitted to travel out of the rigid base 14, out of the secondary package 12 and into the atmosphere beyond the secondary package 12 walls, as shown in FIG. 4, all while preventing the air or atmosphere from outside the package 10 from entering into the secondary package 12 and possibly reacting with the packaged ground coffee 30 to reduce the freshness and flavor of the coffee 30. In one aspect, the one-way valve 22 may comprise a disk-shaped bottom valve, as shown in FIG. 1. In another aspect, the one-way valve may comprise a foil one-way valve placed on an outer surface of the secondary package 12, as previously described as an option for the vented film membrane 18.

Optionally, the rigid base 14 can contain a deformation feature 48 which can provide for reduction of headspace in the rigid base 14 to enable the contents of the rigid base 14, i.e., the coffee 30, to support a top load placed upon the rigid base 14 rather than placing all that weight upon the rigid base 14 alone. In one aspect, the deformation feature 48 can comprise an accordion-like ridge around the perimeter of the rigid base 14, as shown in FIG. 7. The deformation feature 48 can decompress when a load is released, and can become compressed when a load is placed upon it, where the deformation feature 48 can compress until it contacts the coffee, which then provides additional support. The deformation feature 48 allows for the rigid base 14 to become compressed so that the majority of the load is placed upon the coffee, rather than on the walls of the rigid base 14. This compression also reduces the headspace in the rigid base 14.

When it is desired to access the packaged coffee product, the outer secondary package 12 can first be removed. Upon removing the outer secondary package 12, the three rigid packages 14 are accessible and can be removed from the interior 42 of the secondary package 12. A first rigid package 14 can be opened by removing the vented film 18, thus exposing the opening 28 in the rigid base 14 and providing an access to the roast and ground coffee 30 stored in the interior 40 of the base 14. Optionally, a small pull tab 50 can be provided at an edge of the vented film membrane 18 to assist in removing the film membrane 18. In one aspect, the pull tab 50 may be provided at one of the corners of the film membrane 18. After the desired amount of coffee 30 is removed by the user, the opening 28 can be covered by placing an overcap or lid 16 over the opening 28 to reclose the opened rigid base 14. While the rigid packages 14 are stored inside of the secondary package 12, the lid 16 can be placed over any of the rigid bases 14 and over the vented film 18 to store the lid 16 until the first rigid base 14 is opened. After the coffee 30 in the first rigid base 14 is completely consumed, a second rigid base 14 can be opened and the lid 16 can be transferred to the subsequently opened rigid base 14 to cover the opening 28. This step of transferring the lid between opened and consumed packages can be continued between all of the packaged rigid bases until they are all consumed. Alternatively, one or more lids can be provided. In one aspect, there can be one lid provided for each rigid base in the package.

While the first rigid base 14 is being used, the remaining rigid bases 14 can remain closed with their vented film 18 intact until ready to be consumed. Thus, the remaining, unopened rigid bases 14 can be stored in a consumer's home until ready for consumption, while the vent 20 in the vented film 18 can still provide an egress for stored gases from the interior 40 of the rigid base 14.

Alternatively, instead of the film membrane 18 containing a venting feature, a sidewall 26 of the rigid container 14 may include the venting feature. In one aspect, the sidewall 26 of the rigid container 14 may include a one-way valve. The one-way valve can function similarly to the one-way valve on the secondary package 12, such that gases released from the roast and ground coffee can exit through the valve and into the atmosphere. The one-way valve on the base 14 can also preventingress of air or other gases into the rigid container 14. Therefore, an overwrap having a venting feature may not be necessary when the base 14 includes a one-way valve or, alternatively, an oxygen permeable overwrap or any other overwrap may be provided.

The rigid packages 14 can be sized such that the roast and ground coffee 30 stored therein can be consumed in a sufficient timeframe as compared to larger bulk containers. In one aspect, the rigid packages 14 can be sized to contain about one pound of roast and ground coffee. In other aspects, the size of the container can vary such that it can hold more or less. The shape of the rigid base 14 can be any appropriate shape for packaging, and in one aspect, can be a square or rectangular shape. The rigid base 14 can include a volume between about 9 ounces and about 20 ounces. In one aspect, the rigid base 14 has a volume of about 11 ounces. The secondary package 12 can be sized large enough to fully enclose and surround the multiple rigid bases 14. In one aspect, the secondary package 12 is large enough to surround three multiple rigid bases 14, as shown in FIG. 1. In another aspect, the secondary package 12 can have a volume of about 18 to about 48 ounces. In one example, the secondary package 12 can have a volume of about 33 ounces. In yet another aspect, the secondary package 12 can have dimensions of, for example, a height of about 6 inches to about 10 inches, length of about 4 inches to about 6 inches, and a width of about 4 inches to about 8 inches. In one example, the secondary package can have dimensions of a height of about 6 inches, a length of about 5 inches and a width of about 7 inches. The secondary package 12 may also optionally contain a handle 38 or other carrying device along an outer surface of the secondary package 12. In one aspect, the handle 38 can be provided on the top panel 36 of the secondary package 12.

The size of the one-way valve 22 positioned in the secondary package 12 can be large enough to allow the gases stored within the interior 42 to vent through the valve 22, yet prevent the air outside the secondary package 12 from entering the interior 42. In one aspect, the valve 22 can have a hole that is approximately 3 mm×1 mm in area. Similarly, the size of the vent 20 in the vented film 18 covering the rigid base 14 can also be sized appropriately for allowing egress of gases stored within the interior 40 of the rigid base 14. In one aspect, the vent 20 can be sized about 1 mm×about 1 mm, but can be larger or smaller depending on the use.

The material of construction of the rigid base 14 can be any material that is appropriate for coffee storage. In one aspect, the rigid base 14 may comprise a material made out of high density polyethylene, ethylene vinyl alcohol, polypropylene, poly lactic acid (PLA), other suitable bio-based materials, and combinations thereof. In another aspect the rigid base 14 can comprise polypropylene with an ethylene vinyl alcohol barrier layer, or in yet another aspect, a high density polyethylene with an ethylene vinyl alcohol barrier layer. The material of the rigid base 14 can be provided such that the rigid base 14 may be formed by thermoforming or injection-molding techniques. The rigid base 14 can have a thickness, for example, in the range of about 20 mils to about 35 mils. The terms “rigid” and “semi-rigid” are used herein to indicate that the structures made of these materials have the ability to generally retain their respective shapes during normal handling. Where the term “rigid” is used herein it may also be substituted with the word “semi-rigid,” and vice versa. The secondary package 12 can comprise an appropriate material for housing the rigid bases 14 therein while also providing a sealed interior 42 area for preventing ingress of air from outside of the secondary package 12 through the package 12 or through the valve 22. In one aspect, the secondary package 12 may be a film that is shrink-wrapped around the multiple primary packages 14, or in another aspect may be a film that is flow-wrapped. In yet another aspect, the secondary package 12 can comprise polyester, aluminum, linear low density polyethylene (LLDPE), metallized polyethylene, any suitable oxygen barrier flexible films, and combinations thereof. In one example, a reverse print polyester/aluminum/LLDPE coextruded sealant structure can be provided. In another aspect, the secondary package 12 can comprise a reverse print polyester/metallized polyethylene/LLDPE sealant structure.

The vented film membrane 18 placed over the opening 28 in the rigid base 14 can comprise any appropriate film material for sealing the rigid base 14 and allowing gas to escape through a vent 20 therein. In one aspect, the film membrane may comprise polyester, aluminum, high density polyethylene (HDPE), metallized polyethylene, any suitable oxygen barrier flexible films, and combinations thereof. By one approach, a film membrane having a polyester/aluminum/HDPE sealant structure can be provided. In another aspect, the film membrane may comprise a polyester/metallized polyethylene/HDPE sealant structure. The film membrane 18 can have a thickness in the range of about 2 mil to about 3.5 mil. The one-way valve 22 may comprise any appropriate material that will permit gas to pass therethrough while being combined with the secondary package 12. In one aspect, the valve 22 may comprise plastic, foil or a flexible film.

From the foregoing, it will be appreciated a packaging system for a coffee product and method for packaging same is provided. However, numerous modifications and variations could be made thereto by those skilled in the art without departing from the scope of the packaging system and method as set forth in the claims. Therefore, the disclosure is not limited to the aspects and embodiments described hereinabove, or to any particular embodiments. Various modifications to the system and method could be made which can result in substantially the same packaging system and method.

What is claimed is:

1. A packaged roast and ground coffee product comprising:
one or more primary containers for storing the roast and ground coffee product therein and each having a base, the base having a bottom wall and an upstanding sidewall, and a flexible film membrane covering an opening in the base;
an opening either on the flexible film membrane or on a portion of a finish area of the base that permits egress of carbon dioxide gas;
a secondary package that surrounds the one or more primary containers, forming an enclosure around the one or more primary containers; and
a one-way valve positioned on the secondary package that permits egress of carbon dioxide gas released from the one or more primary containers but prevents ingress of gases from outside of the secondary package through the valve.

2. The packaged roast and ground coffee product of claim 1, wherein at least two primary containers are packaged together in the secondary package and the at least two primary containers are stacked.

3. The packaged roast and ground coffee product of claim 1, wherein the bottom wall of the primary container has an indented portion with at least one channel extending from the indented portion toward an edge of the bottom wall to provide a pathway for gases to travel when the one or more primary containers are in a stacked configuration.

4. The packaged roast and ground coffee product of claim 1, wherein the packaged roast and ground coffee product further comprises a lid that can fit over the opening of the base.

5. The packaged roast and ground coffee product of claim 1, wherein the base further comprises a deformation feature that allows the sidewall of the base to become compressed when a load is placed on top of the base, the sidewall compresses until it contacts the roast and ground coffee product therein that provides support for the load.

6. The packaged roast and ground coffee product of claim 1, wherein the base is made from a material selected from the group comprising polypropylene, polyethylene, ethylene vinyl alcohol, poly lactic acid, other suitable bio-based materials and combinations thereof, and the secondary package is made from a material selected from the group comprising polyester, polyethylene, aluminum, linear low density polyethylene, other suitable oxygen barrier films and combinations thereof.

7. The packaged roast and ground coffee product of claim 1, wherein the primary container has a volume of between about 9 and about 20 ounces and the secondary package has a volume between about 18 ounces and about 48 ounces.

8. The packaged roast and ground coffee product of claim 1, wherein the one-way valve is positioned on a top panel of the secondary package.

9. A method for packaging roast and ground coffee, the method comprising the steps of:
filling roast and ground coffee through an opening in a container;
sealing the opening in the container with a flexible film membrane, the flexible film membrane having a vent that permits egress of gas; and
surrounding the sealed container with an overwrap, the overwrap having a one-way valve for venting the gas from an interior of the overwrap through the valve but not permitting gas to enter the valve and into the interior of the overwrap.

10. The method of claim 9, further comprising the step of providing a lid that fits over the opening in the container.

11. The method of claim 9, further comprising the step of compressing the container along a deformation feature when a load is placed on top of the container, the container compressing until contact is made with the roast and ground coffee product therein that then provides support for the load.

12. The method of claim 9, wherein the filled container is stacked on top of another filled base container within the overwrap.

13. The method of claim 9, further comprising the step of providing a pathway for gases to travel along a bottom wall of the container when the container is in a stacked configuration with at least a second container, the pathway comprising an indented portion on the bottom wall with at least one channel extending therefrom toward an edge of the bottom wall.

14. A multiple compartment coffee container comprising:
at least two semi-rigid or rigid containers for storing a roast and ground coffee product therein, the coffee containers each sealed with a vented film membrane that permits passage of carbon dioxide gases from the roast and ground coffee to pass therethrough; and
an outer package for surrounding the at least two coffee containers, the outer package having a one-way valve to permit venting of the carbon dioxide gases therethrough but preventing ingress of air or other gas.

15. The multiple compartment coffee container of claim 14, wherein the vented film membrane includes a vent opening that permits the carbon dioxide gases to pass therethrough but to limit passage of air into the container.

16. The multiple compartment coffee container of claim 14, wherein the at least two coffee containers are stacked within the outer package.

17. The multiple compartment coffee container of claim 14, wherein the coffee container is opened by removing the vented film membrane to reveal an opening in the coffee container and reclosed by placing a lid over the opening, after first having removed the outer package.

18. The multiple compartment coffee container of claim 14, wherein the sealed coffee container continues to vent carbon dioxide gas through the vented membrane and to the atmosphere after removing the outer package.

19. The multiple compartment coffee container of claim 14, wherein the at least two coffee containers comprise three coffee containers.

20. The multiple compartment coffee container of claim 14, wherein the container has a bottom wall that includes a recessed portion and at least one channel extending from the recessed portion toward an edge of the bottom wall to provide a pathway for gases to travel when the containers are in a stacked configuration.
